(19) United States
(12) Patent Application Publication
(10) Pub. No.: US 2023/0046226 A1
(43) Pub. Date: Feb. 16, 2023

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventors: Hirotake SASAKI, Kanagawa (JP); Kiyoshi Iida, Kanagawa (JP); Takeshi Nagamine, Kanagawa (JP)

(73) Assignee: FUJIFILM Business Innovation Corp., Tokyo (JP)

(21) Appl. No.: 17/549,109

(22) Filed: Dec. 13, 2021

(30) Foreign Application Priority Data
Aug. 16, 2021 (JP) 2021-132322

(51) Int. Cl. G06V 10/22; G06V 10/40; G06T 7/70

(52) U.S. Cl. CPC G06V 10/22; G06V 10/40; G06T 7/70

(57) ABSTRACT

An information processing apparatus includes a processor configured to: acquire a captured image of an object; specify a first area of the object in the captured image, the first area being an area occupied by a work target that is a target to be worked on; process the captured image to make a second area other than the first area invisible to generate a processed image; in response to a change in the first area with a deformation of the work target, apply a deformation area instead of the first area to make a second area obtained by the application invisible to generate a processed image, the deformation area being an area defined by a pre-registered shape of the work target after deformation; and transmit the processed image.

### CROSS-REFERENCE TO RELATED APPLICATIONS

This application is based on and claims priority under 35 USC 119 from Japanese Patent Application No. 2021-132322 filed Aug. 16, 2021.

### BACKGROUND

### (i) Technical Field

The present disclosure relates to an information processing apparatus, a non-transitory computer readable medium, and an information processing method.

### (ii) Related Art

Japanese Patent No. 6748793 discloses a maintenance assistance system. The maintenance assistance system includes a wearable terminal having imaging means and configured to be worn by a maintenance worker; first specifying means for specifying, with reference to a predetermined reference point in a captured image acquired by the imaging means in an initial state, a predetermined first three-dimensional area including a maintenance target and/or a predetermined second three-dimensional area excluding the maintenance target; second specifying means for specifying a mask pixel area excluding an effective pixel area corresponding to the first three-dimensional area and/or specifying a mask pixel area corresponding to the second three-dimensional area in a captured image acquired by the imaging means in a post-movement state in which the wearable terminal has moved; processed image generation means for making the mask pixel area specified by the second specifying means invisible in the captured image acquired by the imaging means in the post-movement state to generate a processed image; and communication means for transmitting the processed image generated by the processed image generation means to a maintenance-assistant-side terminal. The reference point does not need to be included in the captured image acquired by the imaging means in the post-movement state.

Japanese Unexamined Patent Application Publication No. 2018-36812 discloses a remote IT operation work assistance system for assisting in operation work of an IT system. The remote IT operation work assistance system includes a first mobile terminal of a first worker who works on a local IT system; a second mobile terminal of a second worker who works in a remote location; and a server. The IT system has a device to which an ID medium having an ID is attached. The remote IT operation work assistance system includes settings information including association information between the device and the ID, a user ID of the first worker, a user ID of the second worker, and information on a privilege of the second worker to reference the device identified by the ID. The server detects the ID of the ID medium from a video of the device captured by the first worker using a camera, determines whether the second worker has a privilege to reference the device identified by the detected ID on the basis of the settings information, subjects the captured image to a masking process in which an image portion of the device that the second worker has a privilege to reference is set as an unmasked area and an image portion of the device that the second worker has no privilege to reference is set as a masked area to generate a masking video, and provides the masking video to the second mobile terminal to display the masking video on a display screen.

Japanese Unexamined Patent Application Publication (Translation of PCT Application) No. 2020-537230 discloses a method of excluding portions of a scene from a video signal in a local augmented reality (AR) environment for data capture and transmission compliance. The method includes the steps of slaving a pointing direction of a video camera to user motion; capturing a video signal within a video camera field of view (FOV) of an object in a local scene; receiving from a remote location hand gestures for manipulation of the object; overlaying the hand gestures on the video signal and displaying an augmented reality to the user to instruct the user in manipulation of the object; determining whether the pointing direction of the video camera satisfies an alignment condition to a marker in the local scene such that the video camera FOV lies within a user-defined allowable FOV about the marker before capturing the video signal; and if the alignment condition is not satisfied, controlling the camera to exclude at least a portion of the camera FOV that lies outside the user-defined allowable FOV from capture within the video signal.

### SUMMARY

A technique has been proposed for transmitting a video captured by a local worker to a terminal operated by a remote assistant to share the state of work between the local worker and the remote assistant to assist in the work.

The captured video may include information other than a work target that is a target to be worked on. Accordingly, an area occupied by the work target at the position of the worker may be designated in advance, and an image of only the area occupied by the work target may be captured and transmitted to the terminal after a background, which is an area excluding the work target registered in advance, is processed to prevent leakage of information such as confidential information.

However, if the area occupied by the work target changes along with work such as opening a door of the work target or removing parts of the work target, a portion of the work target may be recognized as a background, or a video may be captured without processing of the background. That is, the captured video may be processed excessively or insufficiently.

Aspects of non-limiting embodiments of the present disclosure relate to an information processing apparatus, a non-transitory computer readable medium, and an information processing method that prevent a captured video from being excessively or insufficiently processed even upon a change in an area occupied by a work target.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: acquire a captured image of an object; specify a first area of the object in the captured image, the first area being an area occupied by a work target that is a target to be worked on; process the captured image to make a second area other than the first area invisible to generate a processed image; in response to a change in the first area with a deformation of the work target, apply a deformation area instead of the first area to make a second area obtained by the application invisible to generate a processed image, the deformation area being an area defined by a pre-registered shape of the work target after deformation; and transmit the processed image.

### BRIEF DESCRIPTION OF THE DRAWINGS

Exemplary embodiments of the present disclosure will be described in detail based on the following figures, wherein:

FIG. 1 is a schematic diagram illustrating an example configuration of an information processing system according to the exemplary embodiments;

FIG. 2 is a block diagram illustrating an example hardware configuration of an information processing apparatus according to the exemplary embodiments;

FIG. 3 is a block diagram illustrating an example functional configuration of the information processing apparatus according to the exemplary embodiments;

FIG. 4 is a schematic diagram illustrating an example of three-dimensional space information for describing Simultaneous Localization and Mapping (SLAM) according to the exemplary embodiments;

FIG. 5 is a schematic diagram illustrating an example of three-dimensional space information for describing a space occupied by a work target according to the exemplary embodiments;

FIG. 6 is a schematic diagram illustrating an example image according to the exemplary embodiments;

FIG. 7 is a schematic diagram illustrating an example processed image according to the exemplary embodiments;

FIG. 8 is a diagram illustrating an example target space for describing switching in response to a deformation of the work target according to the exemplary embodiments;

FIG. 9 is a flowchart illustrating an example process for generating a processed image according to a first exemplary embodiment;

FIG. 10 is a diagram illustrating an example target space for describing detection of a deformation according to a second exemplary embodiment;

FIG. 11 is a diagram illustrating an example target space for describing detection of a deformation according to the second exemplary embodiment; and

FIG. 12 is a flowchart illustrating an example process for generating a processed image according to the second exemplary embodiment.

### DETAILED DESCRIPTION

### First Exemplary Embodiment

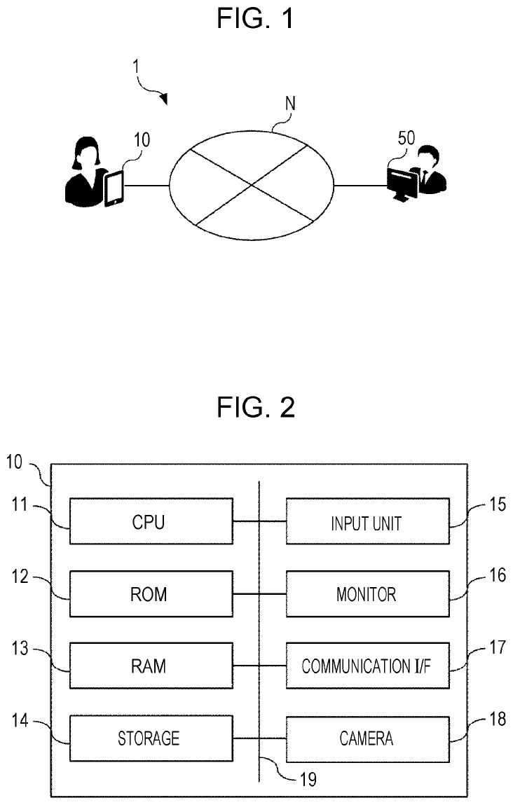

Exemplary embodiments of the present disclosure will be described in detail hereinafter with reference to the drawings. FIG. 1 is a schematic diagram illustrating an example configuration of an information processing system 1 according to a first exemplary embodiment.

In one example, as illustrated in FIG. 1, the information processing system 1 includes an information processing apparatus 10 to be operated by a worker, and a terminal 50 to be operated by an assistant. The information processing apparatus 10 and the terminal 50 are connected to each other via a network N.

The information processing apparatus 10 is a terminal such as a tablet including a monitor 16 and a camera 18 described below. The information processing apparatus 10 acquires an image of a target to be worked on (hereinafter referred to as a “work target”) and transmits the acquired image to the terminal 50. If the image to be transmitted to the terminal 50 includes an object other than the work target and a background, the information processing apparatus 10 processes the image to make the object other than the work target and the background invisible in the image. Further, the information processing apparatus 10 acquires from the terminal 50 information on assistance in the work performed by the assistant (the information is hereinafter referred to as “assistance information”) and presents the assistance information to the worker.

The terminal 50 acquires an image from the information processing apparatus 10 and presents the image to the assistant. Further, the terminal 50 transmits assistance information input from the assistant to the information processing apparatus 10.

In the information processing system 1, the information processing apparatus 10 transmits and presents an image captured by the worker to the terminal 50, and the terminal 50 transmits and presents assistance information input from the assistant to the information processing apparatus 10. The information processing system 1 allows the worker to receive the assistance information from the assistant at a remote location through the information processing apparatus 10 and to perform work on the work target.

In this exemplary embodiment, an image is captured, by way of example but not limitation. A video may be captured.

Next, the hardware configuration of the information processing apparatus 10 will be described with reference to FIG. 2. FIG. 2 is a block diagram illustrating an example hardware configuration of the information processing apparatus 10 according to this exemplary embodiment.

As illustrated in FIG. 2, the information processing apparatus 10 according to this exemplary embodiment includes a central processing unit (CPU) 11, a read only memory (ROM) 12, a random access memory (RAM) 13, a storage 14, an input unit 15, a monitor 16, a communication interface (communication I/F) 17, and a camera 18. The CPU 11, the ROM 12, the RAM 13, the storage 14, the input unit 15, the monitor 16, the communication I/F 17, and the camera 18 are connected to one another via a bus 19. The CPU 11 is an example of a processor.

The CPU 11 controls the overall operation of the information processing apparatus 10. The ROM 12 stores various programs including an information processing program according to this exemplary embodiment, data, and the like. The RAM 13 is a memory used as a work area for executing various programs. The CPU 11 loads a program stored in the ROM 12 into the RAM 13 and executes the program to perform a process for processing an image to generate a processed image. In one example, the storage 14 is a hard disk drive (HDD), a solid state drive (SSD), a flash memory, or the like. The storage 14 may store the information processing program and the like. The input unit 15 includes a touch panel and a keyboard for receiving text input and the like. The monitor 16 displays text and an image. The communication I/F 17 transmits and receives data. The camera 18 is an imaging device for capturing an image of the work target. The camera 18 is an example of an “image capturing unit”.

Next, the functional configuration of the information processing apparatus 10 will be described with reference to FIG. 3. FIG. 3 is a block diagram illustrating an example functional configuration of the information processing apparatus 10 according to this exemplary embodiment.

In one example, as illustrated in FIG. 3, the information processing apparatus 10 includes an acquisition unit 21, a detection unit 22, an estimation unit 23, a setting unit 24, a specifying unit 25, a generation unit 26, a storage unit 27, an acceptance unit 28, and a notification unit 29. The CPU 11 executes the information processing program to function as the acquisition unit 21, the detection unit 22, the estimation unit 23, the setting unit 24, the specifying unit 25, the generation unit 26, the storage unit 27, the acceptance unit 28, and the notification unit 29.

The acquisition unit 21 acquires an image including an object that is a work target whose image is captured by the camera 18. Further, the acquisition unit 21 acquires designation of a work target that is a target to be worked on among objects included in the image. The work target according to this exemplary embodiment is designated by reading a quick response code (QR code (registered trademark)) on the surface of the object, by way of example but not limitation. Identified objects may be displayed on the monitor 16 to allow a user to select the work target from among the objects.

The detection unit 22 detects feature points indicating the object from the acquired image. The feature points are points indicating the edges, the corners, and the like of the object included in the image.

The estimation unit 23 estimates the position and direction of the worker (the camera 18) by using the detected feature points and estimates a target space in the position and direction of the worker. Specifically, Simultaneous Localization and Mapping (SLAM) technology is used to estimate position information indicating the position of the worker, direction information indicating the direction of the worker, and the target space.

For example, the worker starts capturing an image of the work target by causing a QR code (registered trademark) attached to the work target, and the detection unit 22 detects the feature points included in the captured image. The estimation unit 23 compares the feature points included in a plurality of images captured over time and estimates positions and directions at and in which the worker (the camera 18) captures the images from the amount of change of the feature points.

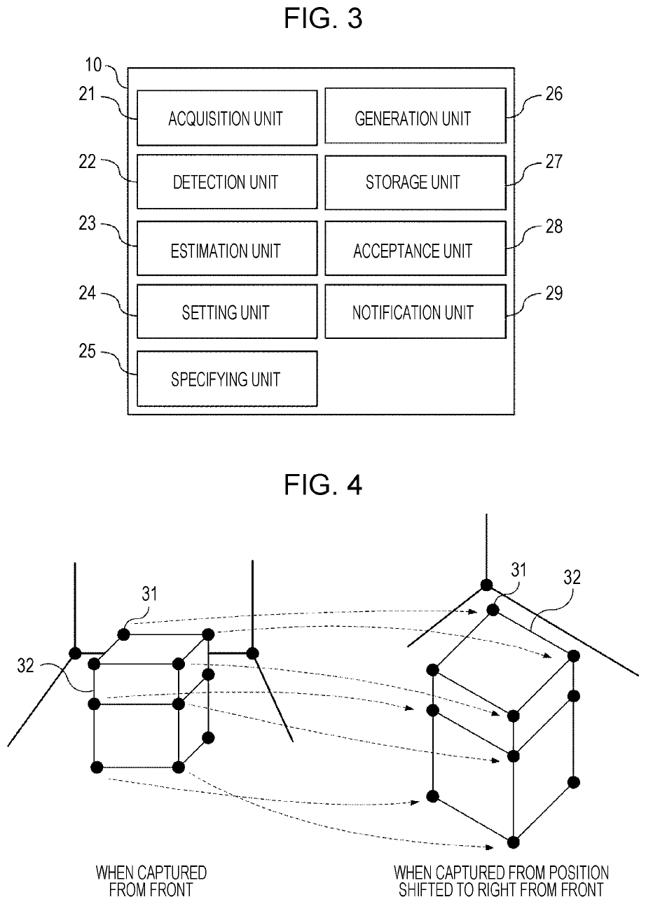

In one example, as illustrated in FIG. 4, the estimation unit 23 can keep track of feature points 31 included in captured images to estimate position information and direction information of the worker and a target space 33. In this exemplary embodiment, the estimation unit 23 estimate the position of the worker at the time of start of image capturing by reading a QR code (registered trademark) attached to a work target 32, by way of example but not limitation. For example, the worker may start capturing an image of the work target 32 at a predetermined position. In this exemplary embodiment, furthermore, the estimation unit 23 estimates the position information and direction information of the worker from the amount of change of the feature points 31, by way of example but not limitation. For example, a feature point map having feature points 31 of a space in which the worker is present may be created in advance, and the estimation unit 23 may compare feature points 31 included in a captured image with the feature points 31 in the feature point map to estimate the position information and direction information of the worker.

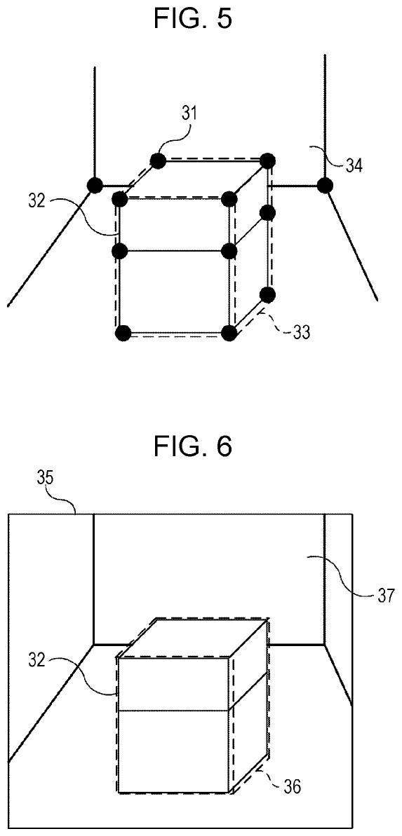

The setting unit 24 sets three-dimensional space information by using the acquired image and the detected feature points. Specifically, in one example, the setting unit 24 sets three-dimensional space information illustrated in FIG. 5. As illustrated in FIG. 5, the setting unit 24 identifies a space included in the image and individual objects by using the feature points 31. The setting unit 24 sets, as three-dimensional space information, a space 33 occupied by the work target 32 designated by the user and a space 34 occupied by a non-work target (such as another object or a background) among the objects. The space 33 is hereinafter referred to as the “target space” 33, and the space 34 is hereinafter referred to as the “non-target space” 34. The target space 33 is an example of a “first space”, and the non-target space 34 is an example of a “second space”.

The setting unit 24 further sets information for the non-target space 34 to make the non-target space 34 invisible as a background not to be visually recognized. This information is hereinafter referred to as “invisibility information”. That is, the three-dimensional space information is a three-dimensional coordinate space in which the feature points 31 indicating the object are set, and includes the target space 33 occupied by the designated work target 32, and the non-target space 34 that is a space excluding the target space 33.

If three-dimensional space information is held, the setting unit 24 sets the three-dimensional space information by performing positioning of the non-target space 34 and the target space 33 in the position information and direction information of the worker by using the acquired image and the detected feature points 31.

In one example, as illustrated in FIG. 6, the specifying unit 25 specifies, in an acquired image 35, an area (hereinafter referred to as a “target area”) 36 occupied by the work target 32 among objects included in the image 35. Specifically, the specifying unit 25 compares the acquired image 35 with the three-dimensional space information to specify, in the image 35, the target area 36 corresponding to the target space 33 in the three-dimensional space information. The specifying unit 25 further specifies an area 37 other than the target area 36 as a background to be processed. The area 37 is hereinafter referred to as the “non-target area” 37 and corresponds to the non-target space 34 in the three-dimensional space information. The target area 36 is an example of a “first area”, and the non-target area 37 is an example of a “second area”.

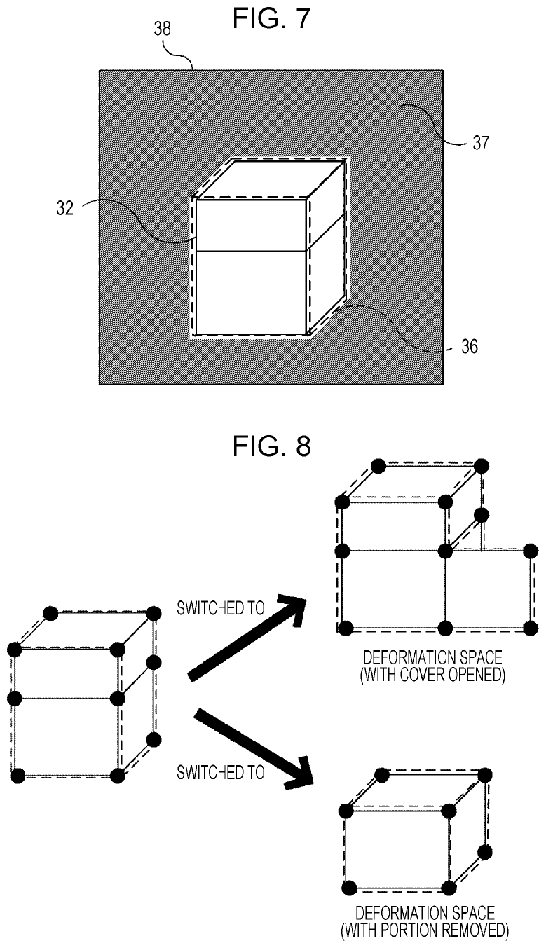

In one example, as illustrated in FIG. 7, the generation unit 26 processes the acquired image 35 to make the non-target area 37 corresponding to the non-target space 34 for which the invisibility information is set invisible in the acquired image 35 to generate an image (hereinafter referred to as a “processed image”) 38. Examples of the processing for making the non-target area 37 invisible include blurring the edges of the object, characters, and the like, and blackening the non-target area 37.

The storage unit 27 stores shapes of deformed work targets.

In response to a change of the target area 36 with a deformation of the work target 32, the acceptance unit 28 accepts, from the user, an instruction for switching the target area 36 to an area (hereinafter referred to as a “deformation area”) defined by a pre-registered shape of the work target 32 after deformation, and the shape of the deformed work target 32.

In response to detection of a deformation of the work target 32 from the amount of change of the feature points 31, the notification unit 29 provides a notification of switching of the target area 36 to the deformation area.

Next, prior to the description of the operation of the information processing apparatus 10, a description of a method for switching the target area 36 to the deformation area will be given with reference to FIG. 8. FIG. 8 is a diagram illustrating an example of the target space 33 for describing switching in response to a deformation of the work target 32.

For example, the work target 32 is an image forming apparatus. In this case, a door of the image forming apparatus may be opened or closed, and the image forming apparatus may be deformed in shape. If the work target 32 is deformed, in the target space 33 set by the setting unit 24 before the deformation, a portion of the work target 32 may be made invisible as a result of processing, or an area to be made invisible may fail to be made invisible as a result of processing.

In the information processing apparatus 10 according to this exemplary embodiment, accordingly, the storage unit 27 stores, for each work target 32, a shape of the work target 32 after deformation in advance, and the information processing apparatus 10 accepts, from the user, designation of a shape corresponding to the shape of the deformed work target 32 from among the shapes stored in advance.

The acceptance unit 28 accepts designation of a shape of the deformed work target 32 from the user, and the setting unit 24 sets a space (hereinafter referred to as a “deformation space”) corresponding to the shape of the deformed work target 32 for which the designation is accepted. As illustrated in FIG. 8, in accordance with the designation of the user, the setting unit 24 switches the target space 33 before deformation to the deformation space and sets the deformation space in the three-dimensional space information.

The deformation space is set in the three-dimensional space information in consideration of the estimated position information and direction information. For example, the shape of the work target 32 after deformation stored in the storage unit 27 is the shape of the work target 32 as viewed from the front. In this case, a deformation space corresponding to the estimated position information and direction information (for example, the shape of the deformed work target 32 as viewed from a side) is generated. Accordingly, the shape of the work target 32 after deformation stored in the storage unit 27 is associated with the shape of the work target 32 as viewed from the current position of the worker.

The specifying unit 25 compares the acquired image 35 with the three-dimensional space information and specifies a deformation area in the image 35 corresponding to the deformation space in the three-dimensional space information. The specifying unit 25 further specifies an area other than the deformation area as the non-target area 37 to be processed as a background.

The generation unit 26 makes the non-target area 37 invisible in the image 35 to generate the processed image 38.

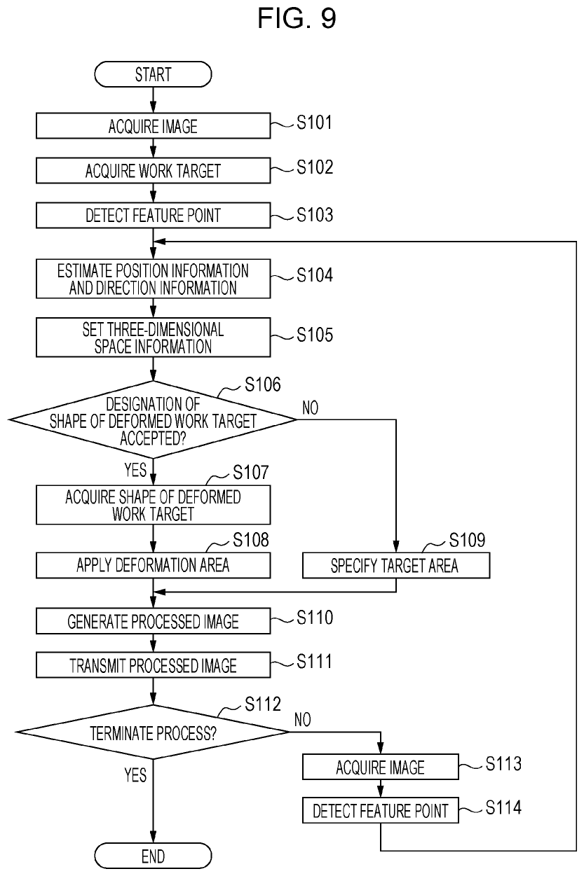

Next, the operation of the information processing apparatus 10 according to this exemplary embodiment will be described with reference to FIG. 9. FIG. 9 is a flowchart illustrating an example process for generating the processed image 38 according to this exemplary embodiment. The CPU 11 reads the information processing program from the ROM 12 or the storage 14 and executes the information processing program to execute the image generation process illustrated in FIG. 9. The image generation process illustrated in FIG. 9 is executed in response to receipt of an instruction from a user to generate the processed image 38, for example.

In step S101, the CPU 11 acquires a captured image 35 of an object including the work target 32.

In step S102, the CPU 11 acquires the work target 32 designated by the user.

In step S103, the CPU 11 detects the feature points 31 of the object from the acquired image 35.

In step S104, the CPU 11 estimates the position information and direction information of the worker from the detected feature points 31 by using SLAM technology.

In step S105, the CPU 11 sets the target space 33 and the non-target space 34 in three-dimensional space information. In the three-dimensional space information, invisibility information is set for the non-target space 34. When a new image 35 is acquired over time and the feature points 31 are detected, the feature points 31 are used to set the target space 33 and the non-target space 34 in the three-dimensional space information.

In step S106, the CPU 11 determines whether designation of a shape of the deformed work target 32 has been accepted from the user. If designation of a shape of the deformed work target 32 has been accepted (step S106: YES), the CPU 11 proceeds to step S107. On the other hand, if designation of a shape of the deformed work target 32 has not been accepted (step S106: NO), the CPU 11 proceeds to step S109.

In step S107, the CPU 11 accepts an instruction to switch to the deformation area and the shape of the deformed work target 32.

In step S108, the CPU 11 sets a deformation space by using the accepted shape of the deformed work target 32, specifies a deformation area corresponding to the deformation space, and applies the deformation area instead of the target area 36.

In step S109, the CPU 11 compares the acquired image 35 with the three-dimensional space information and specifies the target area 36 in the image 35.

In step S110, the CPU 11 performs processing on the non-target area 37 to generate the processed image 38.

In step S111, the CPU 11 transmits the generated processed image 38 to the terminal 50.

In step S112, the CPU 11 determines whether to terminate the process. If the process is to be terminated (step S112: YES), the CPU 11 ends the process of generating the processed image 38. On the other hand, if the process is not to be terminated (step S112: NO), the CPU 11 proceeds to step S113.

In step S113, the CPU 11 acquires a new captured image 35 of an object including the work target 32.

In step S114, the CPU 11 detects the feature points 31 of the object from the acquired image 35. Then, the CPU 11 returns to step S104, performs positioning of the target space 33 and the non-target space 34 by using the detected feature points 31, and sets three-dimensional space information.

As described above, this exemplary embodiment may prevent a captured image from being excessively or insufficiently processed even upon a change in the area occupied by the work target 32.

### Second Exemplary Embodiment

In the first exemplary embodiment, designation of a shape of the deformed work target 32 is accepted from the user. In a second exemplary embodiment, the shape of the deformed work target 32 is detected.

The configuration of the information processing system 1, the hardware configuration of the information processing apparatus 10, and the functional configuration of the information processing apparatus 10 according to this exemplary embodiment are similar to the configuration illustrated in FIG. 1, the hardware configuration illustrated in FIG. 2, and the functional configuration illustrated in FIG. 3 according to the first exemplary embodiment, respectively, and a description thereof will thus be omitted. Also, an example of three-dimensional space information and an example of the captured image 35 and the processed image 38 according to this exemplary embodiment are similar to the example illustrated in FIGS. 4 and 5 and the example illustrated in FIGS. 6 and 7 according to the first exemplary embodiment, respectively, and a description thereof will thus be omitted.

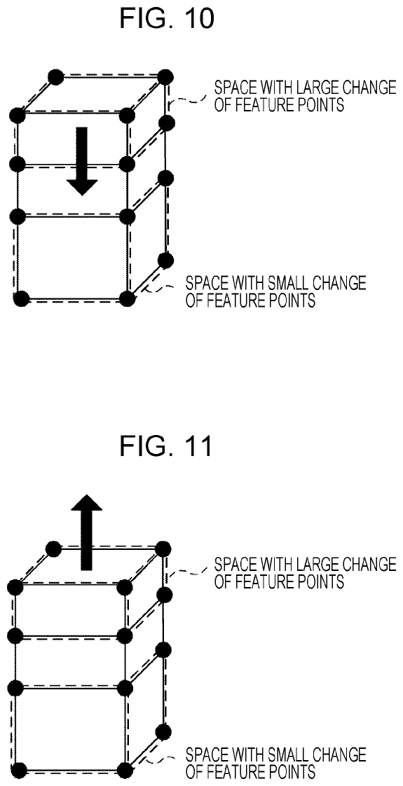

In one example, as illustrated in FIG. 10, the detection unit 22 of the information processing apparatus 10 compares the detected feature points 31 and detects a space with a large change of the feature points 31 and a space with a small change of the feature points 31. For example, as illustrated in FIG. 10, the detection unit 22 detects a space with a large change of the feature points 31 and a space with a small change of the feature points 31. In response to detection of a change that narrows the target space 33, the notification unit 29 provides a notification of designation of a shape of the changed work target 32 and switching of the target space 33. Upon receipt of the notification, the user designates a shape of the changed work target 32 and then performs work on the work target 32 (work for narrowing the target space 33). Thus, after the work target 32 has been deformed, a portion corresponding to the work target 32 before the deformation is prevented from appearing in an image.

In one example, as illustrated in FIG. 11, in response to detection of a change that expands the target space 33, the detection unit 22 detects the shape of the deformed work target 32 by using the detected feature points 31, and the setting unit 24 sets the target space 33 corresponding to the shape of the deformed work target 32. Thus, the work target 32 is not made invisible even without designation of a shape of the deformed work target 32 by the user. In addition, in response to stopping of the change that expands the target space 33, the setting unit 24 sets the target space 33 corresponding to the shape of the deformed work target 32. Thus, a portion corresponding to the background is prevented from appearing in an image during the work of the user.

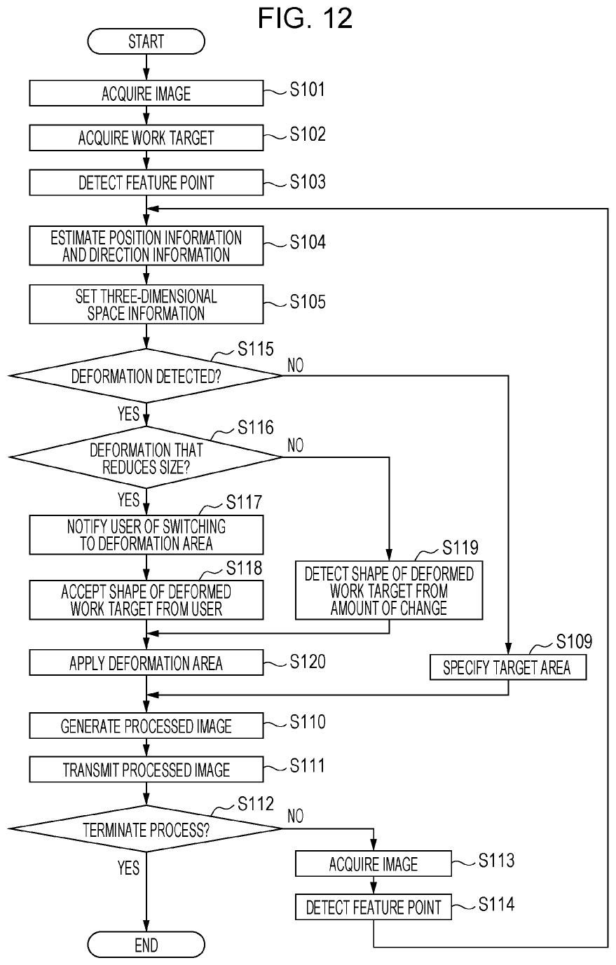

The operation of the information processing apparatus 10 according to this exemplary embodiment will be described with reference to FIG. 12. FIG. 12 is a flowchart illustrating an example process for generating the processed image 38 according to this exemplary embodiment. The CPU 11 reads the information processing program from the ROM 12 or the storage 14 and executes the information processing program to execute an image generation process illustrated in FIG. 12. The image generation process illustrated in FIG. 12 is executed in response to receipt of an instruction from a user to generate the processed image 38, for example. In FIG. 12, steps that are the same as those in the image generation process illustrated in FIG. 9 are denoted by the same reference numerals as those in FIG. 9, and a description thereof will be omitted.

In step S115, the CPU 11 determines whether a deformation of the work target 32 is detected from the amount of change of the feature points 31. If a deformation of the work target 32 is detected (step S115: YES), the CPU 11 proceeds to step S116. On the other hand, if no deformation of the work target 32 is detected (step S115: NO), the CPU 11 proceeds to step S109.

In step S116, the CPU 11 determines whether the detected deformation is a deformation that reduces the size of the target space 33. If the detected deformation is a deformation that reduces the size of the target space 33 (step S116: YES), the CPU 11 proceeds to step S117. On the other hand, if the detected deformation is not a deformation that reduces the size of the target space 33 (i.e., the detected deformation is a deformation that increases the size of the target space 33) (step S116: NO), the CPU 11 proceeds to step S119.

In step S117, the CPU 11 notifies the user of switching to the deformation area.

In step S118, the CPU 11 accepts from the user an instruction to switch to the deformation area and the shape of the deformed work target 32.

In step S119, the CPU 11 detects the shape of the deformed work target 32 from the amount of change of the detected feature points 31.

In step S120, the CPU 11 sets a deformation space by using the shape of the deformed work target 32, specifies a deformation area corresponding to the deformation space, and applies the deformation area instead of the target area 36.

As described above, this exemplary embodiment may prevent the occurrence of unintended insufficient processing.

In the exemplary embodiments described above, the information processing apparatus 10 is a terminal carried by a worker, by way of example but not limitation. The information processing apparatus 10 may be a server. For example, a server including the information processing apparatus 10 may acquire the image 35 and the work target 32 from a terminal carried by a worker, process the image 35 to make the non-target area 37 invisible in the image 35, and transmit the processed image 38 to a terminal carried by an assistant.

While exemplary embodiments of the present disclosure have been described, the present disclosure is not limited to the scope described in the exemplary embodiments. The exemplary embodiments may be modified or improved in various ways without departing from the scope of the present disclosure, and such modifications or improvements also fall within the technical scope of the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the exemplary embodiments, the information processing program is installed in a storage, by way of example but not limitation. The information processing program according to the exemplary embodiments may be provided in such a manner as to be recorded in a computer-readable storage medium. For example, an information processing program according to an exemplary embodiment of the present disclosure may be provided in such a manner as to be recorded in an optical disk such as a compact disc ROM (CD-ROM) or a digital versatile disc ROM (DVD-ROM). An information processing program according to an exemplary embodiment of the present disclosure may be provided in such a manner as to be recorded in a semiconductor memory such as a Universal Serial Bus (USB) memory or a memory card. The information processing program according to the exemplary embodiments may be acquired from an external device via a communication line connected to the communication I/F 17.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
acquire a captured image of an object;
specify a first area of the object in the captured image, the first area being an area occupied by a work target that is a target to be worked on;
process the captured image to make a second area other than the first area invisible to generate a processed image;
in response to a change in the first area with a deformation of the work target, apply a deformation area instead of the first area to make a second area obtained by the application invisible to generate a processed image, the deformation area being an area defined by a pre-registered shape of the work target after deformation; and
transmit the processed image.

2. The information processing apparatus according to claim 1, wherein:
the processor is configured to:
further acquire space information corresponding to the captured image, the space information being information on a three-dimensional space including the object;
detect a feature point indicating the work target from the captured image; and
specify a first space and a second space in the space information by using the feature point, the first space being a space corresponding to the first area, the second space being a space corresponding to the second area.

3. The information processing apparatus according to claim 2, wherein:
the processor is configured to:
set invisibility information for the second space, the invisibility information being information for making an area invisible; and
make the second area corresponding to the second space in the captured image invisible by using the invisibility information to generate a processed image.

4. The information processing apparatus according to claim 3, wherein:
the processor is configured to:
further acquire position information and direction information in the space information, the position information being information on a position of an image capturing unit that obtains the captured image and a position of the work target, the direction information indicating a direction in which the image capturing unit captures an image of the object; and
make the second area invisible in accordance with the position information and the direction information to generate a processed image.

5. The information processing apparatus according to claim 4, wherein:
the processor is configured to:
estimate the position information and the direction information from an amount of change of the feature point.

6. The information processing apparatus according to claim 1, wherein:
the processor is configured to:
store a plurality of deformation areas, each of the plurality of deformation areas comprising the deformation area; and
accept designation of one deformation area among the plurality of deformation areas.

7. The information processing apparatus according to claim 2, wherein:
the processor is configured to:
store a plurality of deformation areas, each of the plurality of deformation areas comprising the deformation area; and
accept designation of one deformation area among the plurality of deformation areas.

8. The information processing apparatus according to claim 3, wherein:
the processor is configured to:
store a plurality of deformation areas, each of the plurality of deformation areas comprising the deformation area; and
accept designation of one deformation area among the plurality of deformation areas.

9. The information processing apparatus according to claim 4, wherein:
the processor is configured to:
store a plurality of deformation areas, each of the plurality of deformation areas comprising the deformation area; and
accept designation of one deformation area among the plurality of deformation areas.

10. The information processing apparatus according to claim 5, wherein:
the processor is configured to:
store a plurality of deformation areas, each of the plurality of deformation areas comprising the deformation area; and
accept designation of one deformation area among the plurality of deformation areas.

11. The information processing apparatus according to claim 1, wherein:
the processor is configured to:
detect a feature point indicating the work target from the captured image; and
in response to detection of a deformation of the work target from an amount of change of the feature point, provide a notification of switching of the first area to the deformation area.

12. The information processing apparatus according to claim 2, wherein:
the processor is configured to:
detect a feature point indicating the work target from the captured image; and
in response to detection of a deformation of the work target from an amount of change of the feature point, provide a notification of switching of the first area to the deformation area.

13. The information processing apparatus according to claim 3, wherein:
the processor is configured to:
detect a feature point indicating the work target from the captured image; and
in response to detection of a deformation of the work target from an amount of change of the feature point, provide a notification of switching of the first area to the deformation area.

14. The information processing apparatus according to claim 4, wherein:
the processor is configured to:
detect a feature point indicating the work target from the captured image; and
in response to detection of a deformation of the work target from an amount of change of the feature point, provide a notification of switching of the first area to the deformation area.

15. The information processing apparatus according to claim 5, wherein:
the processor is configured to:
detect a feature point indicating the work target from the captured image; and
in response to detection of a deformation of the work target from an amount of change of the feature point, provide a notification of switching of the first area to the deformation area.

16. The information processing apparatus according to claim 6, wherein:
the processor is configured to:
detect a feature point indicating the work target from the captured image; and
in response to detection of a deformation of the work target from an amount of change of the feature point, provide a notification of switching of the first area to the deformation area.

17. The information processing apparatus according to claim 11, wherein:
the processor is configured to:
in response to the detected deformation of the work target being a deformation that expands the first area, apply a deformation area corresponding to the deformed work target to generate a processed image.

18. The information processing apparatus according to claim 1, wherein:
the processor is configured to:
in response to receipt of an instruction to switch to a deformation area obtained by narrowing the first area, apply the deformation area in accordance with the instruction to generate a processed image.

19. A non-transitory computer readable medium storing a program causing a computer to execute a process for information processing, the process comprising:
acquiring a captured image of an object;
specifying a first area of the object in the captured image, the first area being an area occupied by a work target that is a target to be worked on;
processing the captured image to make a second area other than the first area invisible to generate a processed image;
in response to a change in the first area with a deformation of the work target, applying a deformation area instead of the first area to make a second area obtained by the application invisible to generate a processed image, the deformation area being an area defined by a pre-registered shape of the work target after deformation; and
transmitting the processed image.

20. An information processing method comprising:
acquiring a captured image of an object;
specifying a first area of the object in the captured image, the first area being an area occupied by a work target that is a target to be worked on;
processing the captured image to make a second area other than the first area invisible to generate a processed image;
in response to a change in the first area with a deformation of the work target, applying a deformation area instead of the first area to make a second area obtained by the application invisible to generate a processed image, the deformation area being an area defined by a pre-registered shape of the work target after deformation; and
transmitting the processed image.
